(19) United States
(12) Patent Application Publication
(10) Pub. No.: US 2006/0274815 A1
(43) Pub. Date: Dec. 7, 2006

(54) System and method for selecting a strongest signal across clock domains in an ultra wideband receiver

(75) Inventor: Deepak M. Joseph, Fairfax, VA (US)

Correspondence Address: POSZ LAW GROUP, PLC, 12040 SOUTH LAKES DRIVE, SUITE 101, RESTON, VA, 20191, US

(73) Assignee: FREESCALE SEMICONDUCTOR INC.

(21) Appl. No.: 11/146,110

(22) Filed: Jun. 7, 2005

(51) Int. Cl. H04B 1/00

(52) U.S. Cl. 375/130

(57) ABSTRACT

A system and method for determining a strongest of a radio signal received on at least two signal paths in an Ultra Wideband (UWB) receiver includes determining a signal metric associated with the radio signal in a first signal path and a second signal path and establishing a candidate for the strongest of the radio signal based on which one of the signal metrics in the first and second signal paths crosses a threshold and based on a rule set. The signal paths are associated with independent clock domains which are synchronized, and the signal metrics are available to the respective signal paths and clock domains. Determining on a non-chosen signal path continues and the threshold is updated. A new candidate is established as the strongest if the signal metric associated with the non-chosen signal path crosses the updated threshold.

### FIELD OF THE INVENTION

The present invention relates generally to wireless communication systems, such as ultra wideband (UWB) systems. In particular, the present invention relates to a system and method in a receiver, including receivers located in mobile transceivers, centralized transceivers, related equipment, for facilitating selecting a strongest radio signal between signals or versions of the radio signal received in receiver fingers operating in respective independent clock domains.

### BACKGROUND OF THE INVENTION

Ultra Wideband (UWB) receivers face unique challenges in signal reception due to low signal levels, high signal frequencies, and the like associated with the UWB signal environment. In particular, given that, for reasons understood in the art, rake type receivers are widely used to process multi path components of a transmitted signal, one of the multi path components must be chosen as the component for receive processing. As is understood, rake receivers have processing “fingers” or separate signal paths which generate signal estimates and perform other signal recovery operations such as clock recovery. It is further understood that such operations and processing are generally performed on each of the fingers independently of each other.

While UWB signals are transmitted over the air interface as analog waveforms or wavelets, the waveforms are typically bi-phase encoded and represent digitally encoded information including receiver training information such as clock information embedded in the received signals. Thus, from the initial detection of signal energy, the UWB receiver fingers being processing the received signal to extract clock information and the like and to determine a signal level such as a signal to noise ratio or the like.

Also embedded in the received signal information are known data segments such as a preamble segment, an SSP segment, and the like. Further, when each finger successfully acquires the signal component, a LOCK event occurs. It will be appreciated that generally, by the time the SSP segment is received, one of the fingers should be chosen for further processing, since information following the SSP will be actual payload data. Since, as noted above, each finger independently processes a separate mulitpath component, difficulties can arise in selecting a receiver finger having the strongest signal due to slight timing differences between the occurrence, for example, of LOCK and subsequent receipt of SSP or other significant segments on respective channels. If one finger obtains a LOCK it is common for this finger to be chosen for further processing even though better signal characteristics may exist on other fingers. Similarly, if a finger is chosen based on superior signal characteristics, another finger may obtain LOCK and receive an SSP before the finger with better signal characteristics.

Thus it would be desirable for a receiver to better process signals on receiver fingers while accounting for timing related factors such as the timing associated with obtaining LOCK and receipt of certain segments.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages in accordance with the present invention.

FIG. 1 is a diagram illustrating an Ultra Wideband (UWB) environment including a transmitter and receiver in accordance with various exemplary embodiments of the present invention;

FIG. 2 is a block diagram illustrating various blocks of a receiver in accordance with various exemplary embodiments of the present invention;

FIG. 3 is a diagram of a receiver showing independent clock domains and a system clock domain of a receiver in accordance with various exemplary embodiments of the present invention;

FIG. 4 is a diagram illustrating exemplary UWB waveforms and signal measurement points in accordance with various exemplary embodiments of the present invention;

FIG. 5 is a flow chart illustrating procedures of a method in accordance with exemplary embodiments of the present invention; and

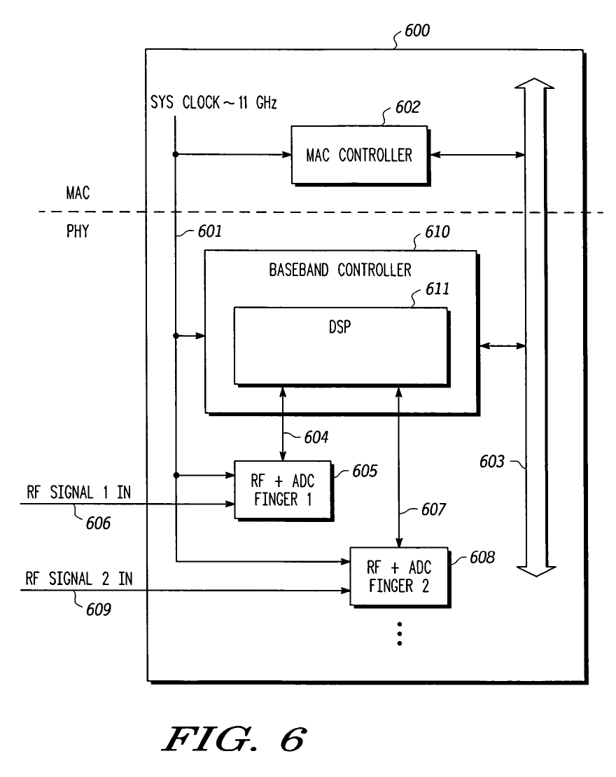

FIG. 6 is a diagram of a receiver apparatus in accordance with various exemplary embodiments of the present invention.

### DETAILED DESCRIPTION OF PREFERRED EMBODIMENTS

UWB Signal Environment

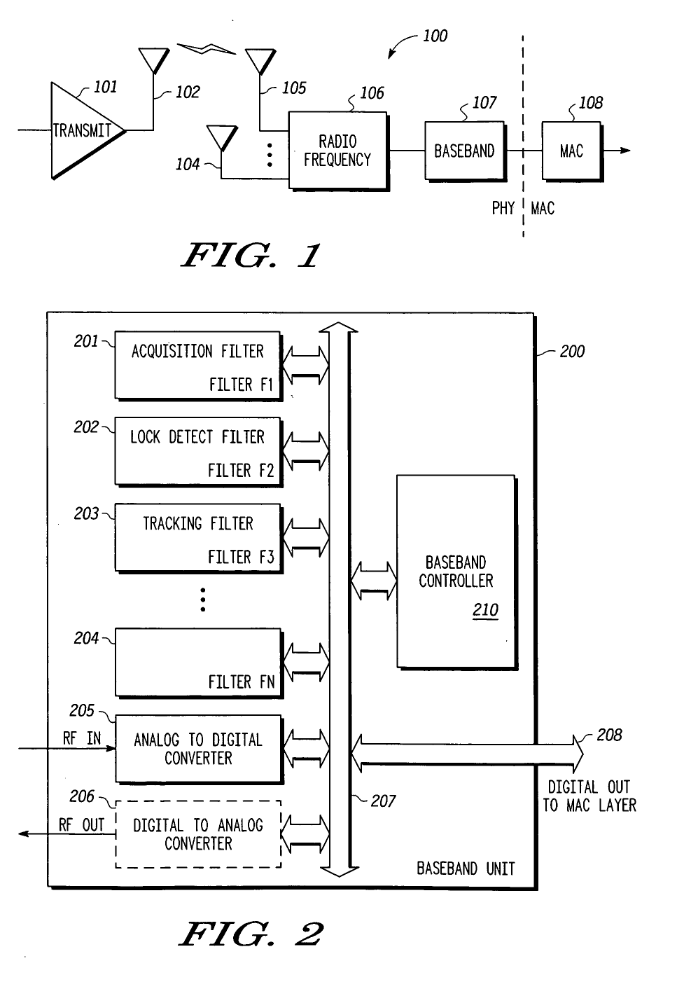

It will be appreciated that a UWB environment 100, for example, as shown in FIG. 1, typically includes a transmitter 101, with one or more transmit antennae 102, and a Radio Frequency (RF) section 106 having one or many antennae such as receive antenna 104 through receiver antenna 105. It will be appreciated that multiple antennae can be used to support transmit/receive diversity systems the use of which, as is understood by one of ordinary skill, is desirable in radio communication systems. As a signal is detected and processing begins, for example in the RF section 106, a baseband module 107 can be used for control and processing of raw signals and performing operations such as selecting receiver fingers and the like. As baseband module 107 extracts data from the received signal and payload information is obtained, such information can be passed along to the media access control (MAC) module 108 for further digital processing. It will also be appreciated in the art that processing downstream from the MAC module 108 can be considered as part of the physical layer (PHY) processing and upstream from and including the MAC module 108 can be considered part of the MAC layer processing.

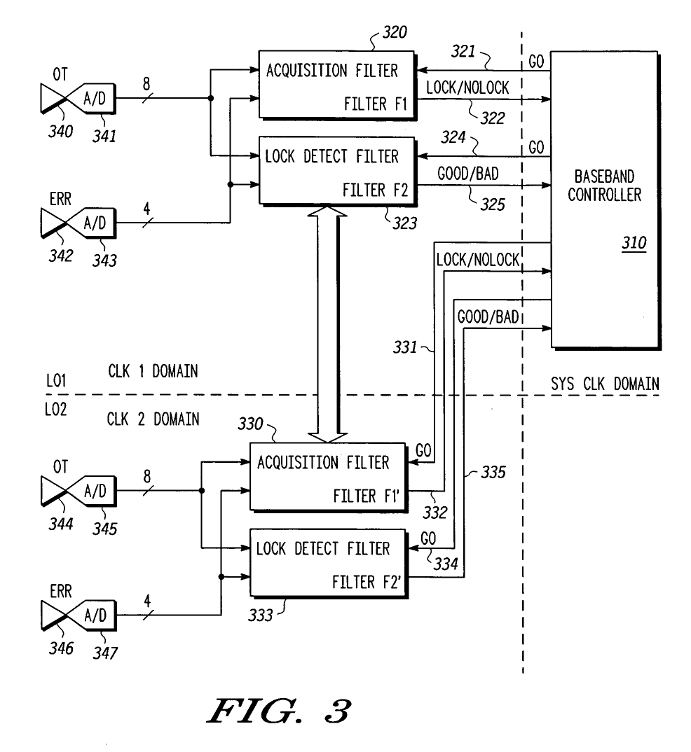

To better understand processing in a UWB receiver, a baseband unit 200 is shown in block diagram form in FIG. 2. It will be appreciated that baseband unit 200 is shown with processing elements associated with a receiver finger and such elements may be duplicated or may be configured to process multiple inputs corresponding to multiple fingers. An RF signal can be input to an analog to digital converter 205 and be converted to a digital signal at or close to baseband frequencies. It will be appreciated that processing in accordance with various exemplary embodiments will generally take place in the digital domain by operation of baseband controller 210 and filters F1 201 -FN 204. If the receiver is configured for transmitting such as in an exemplary transceiver as is common, any RF output can be converted from digital to analog by a digital to analog converter 206. It should be noted that filters F1 201-FN 204 can be configured as special purpose filters. For example filter F1 201 can be configured as an acquisition filter designed to recognize and acquire signal energy from the total energy received on a channel. Filter F2 202 can be configured as a lock detect filter designed to recognize, for example, a preamble in the signal and, possible after iterations through an Automatic Gain Control stage (not shown) can in connection with baseband controller 210, establish a LOCK condition with regard to the signal. It will be appreciated that filters F1 201 -FN 204 along with the baseband controller 210, can be coupled using a bus 207 as will be appreciated. It will further be appreciated that to the extent control lines or analog signal lines commonly known and used in the art are present in baseband unit 200, these line can be considered as part of bus 207. A digital connection 208 to the MAC layer can also be present in the form of an additional connection between the bus 207 and any higher level processors or the like responsible for MAC layer operation as will be appreciated by one of ordinary skill in the art.

Other purposes can be established for filter elements. For example, filter F3 203 can be configured as a tracking filter for tracking signal parameters during reception and allow for gain adjustments or the like once a signal LOCK is achieved. It is important to note that, parameters associated with the filters F1 201-FN 204, such as acquisition related parameters, lock related parameters, tracking related parameters, and the like can be used in accordance with various exemplary embodiments as will be described.

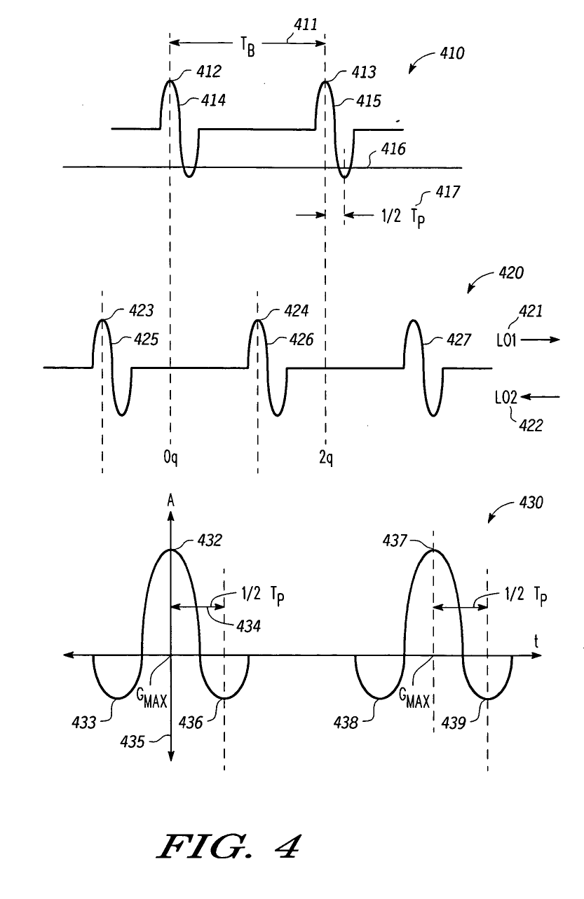

To better understand the operation of the present invention in connection with receiving UWB signals a more detailed diagram of an exemplary receiver is shown in FIG. 3, where a first clock domain CLK 1 DOMAIN and a second clock domain CLK 2 DOMAIN are shown with respective local oscillators LO1 and LO2 as will be appreciated. The first clock domain CLK 1 DOMAIN and the second clock domain CLK 2 DOMAIN are associated with the respective clocks extracted from the incoming multipath component of the received signal and are independent from each other, that is each clock domain can be synchronous with the respective extracted clock and asynchronous, at least to a degree, with respect to the other clock domain. In addition, a system clock domain SYS CLK DOMAIN is associated with the receiver processing circuitry such as the baseband controller 310, and the like which is further independent from the first clock domain CLK 1 DOMAIN and the second clock domain CLK 2 DOMAIN.

When the on-time (OT) and error (ERR) components OT 340 and ERR 342 associated with the first finger and OT 344 and ERR 346 associated with the second finger are received at converters 341, 343, 345, and 347, conversion is conducted and the samples are processed in, for example, filters F1 320, F1 323 for the first finger and F1′ 330 and F2′ 333 for the second finger. The OT 340 and ERR 342 and OT 344 and ERR 346 can then be processed in an acquisition filter F1 320 and an acquisition filters F1′ 330 and a lock filter F2 323 and a lock filter F2′ 333 respectively. It will be appreciated that a baseband controller 310 is used to control the operation of the acquisition and tracking filters and to process inputs from the filters such as LOCK/NOLOCK signals 322 and 332, the GOOD/BAD signals 325 and 335, and to generate GO control outputs 321, 324, 331, 334. As previously noted the clock domains can be synchronized under control of, for example, the baseband controller 310 or other synchronization circuits. The clock domains can also be configured to share information such as signal to noise levels or other parameter levels or filter states such as LOCK or NOLOCK indications or the like therebetween.

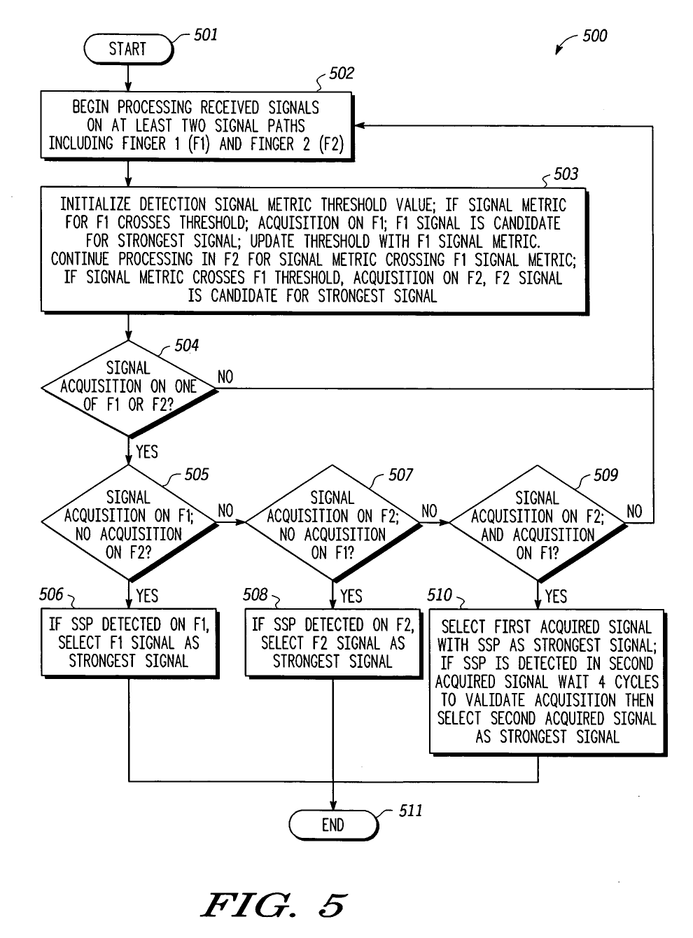

To better appreciate the nature of the transmitted signal, FIG. 4 shows several diagrams of a received signal 410, a local oscillator (LO) signal 420 and a composite signal 430. The received signal 410 is a biphase modulated signal transmitted across an air interface in accordance with a typical UWB radio environment. The received signal 410 can represent encoded information transmitted in accordance with a bit time 411 and each signal portion 414 and 415 have local maxima 412 and 413 relative to a reference level 416 and with a pulse period 417. The LO signal 420 can be mixed with the received signal 410 and shifted in one direction according to a LO1 direction 421 and shifted in another direction according to a LO2 direction 422. It will be appreciated that the LO signal 420 can contain oscillator pulses 425, 426, and 427 with local maxima 423 and 424. The shifting of the LO signal 420 and mixing based on the LO1 direction 421 and the LO2 direction 422 with the received signal 410, inter alia, provides for downconversion of the received signal 410 to baseband frequencies and facilitates maximizing the gain level of the composite signal 430. It can be seen that the composite signal 430 can consist of downconverted pulses having gain maxima 432 and 437, gain minima at 433, 436, 438, and 439 with reference to an amplitude axis 435 and a pulse period 434.

In accordance with various exemplary embodiments, a procedure 500 can be performed so as to determine a strongest signal among signals received on a signal path. After start at 501, processing can begin on at least two signal paths of an exemplary receiver such as a finger 1 (F1) and a finger 2 (F2) at 502. It will be appreciated that the processing can be conducted on a general purpose processor, a dedicated processor, a signal processor, a logic array, or the like, or a combination of these elements operating under the control of, for example, an operating system and various application programs, routines or the like. It will also be appreciated that certain additional circuits or circuit elements may be present as are known in the art such as mixers, bandpass filters, analog to digital converters, or the like. In addition, signal determination can take place during a programmable interval such as a time interval, an acquisition interval, a lock interval, or the like.

Before a strongest signal is chosen, it is necessary to establish an initial detection threshold value for the associated signal metric. The initial detection threshold value can be a zero value, a previous initialization value, a value close to but below a predicted initial detection threshold, or the like, such that, for example, computational complexity and processing time is minimized. The signal metric can be a signal level, a signal to noise ratio or the like as will be appreciated. After the threshold is initialized, the processing can begin on at least the F1 and the F2. The exemplary procedure can take place during normal receive processing such as Acquisition processing, Lock processing, and the like and involves processing the signals and comparing the relative signal strengths of the signals on the F1 and the F2 in relation to the thresholds for as long as possible during sampling windows. Accordingly, if Acquisition is achieved on the F1, and the associated metric crosses the threshold, then the F1 signal is assigned as a candidate for the strongest signal. The threshold value can be updated with the value associated with the F1 signal. Processing can continue on F2 until a new signal level is received which exceeds the updated threshold. If the metric value for the signal on F2 crosses the threshold, the signal on F2 can be assigned as the candidate for the strongest signal, for example, after an unlock delay, and the threshold can be updated and so on at 503. The primary problem arises in that the sampling window for processing the above signals is around 64 samples. If a key packet component having a smaller sampling duration, say 32 sample, such as the SSP portion of the received signal, fails to occur in the finger associated with the presently selected candidate signal, while occurring in the finger associated with a non-candidate signal, the choice for strongest signal will not have been the best choice and there is a non-zero probability of dropping a packet. Accordingly, the application of rules along with the use of a delay factor in unlocking a signal can assist in choosing the strongest signal and avoiding packet loss or delay.

It will be appreciated that while no signal is detected and acquired at 504, the exemplary procedure can loop through 502 and 503. If a signal is acquired on either F1 or F2, the rule set can be invoked. If signal acquisition occurs on F1 and no signal acquisition occurs on F2 at 505, then if the SSP is detected on F1 at 506, the signal associated with F1 is chosen as the strongest signal and the procedure can end at 511. If a signal acquisition occurs on F2 and no signal acquisition occurs on F1 at 507, then if the SSP is detected on F2 at 508, the signal associated with F2 is chosen as the strongest signal and the procedure can end at 511. In the event that signal acquisition occurs on both F1 and F2, at 509, the signal associated with the first finger to receive an SSP is chosen as the strongest signal at 510. It should be noted that in the event an SSP is detected in finger associated with the non-chosen signal, and the non-chosen signal is stronger in terms of the signal metric, then the exemplary procedure waits for 4 sample cycles to validate the non chosen signal, and if the signal is still valid, the non-chosen signal is substituted for the originally chosen finger. It should be noted that information associated with, for example, acquisition, threshold crossing, or the like in each of F1 and F2 can be made available to the other of F1 and F2. The clock domains of FI and F2 can further be synchronized. The procedure can end at 511 although it will be appreciated that the procedure can continue looping or execution can pass to another procedure or the like as noted above.

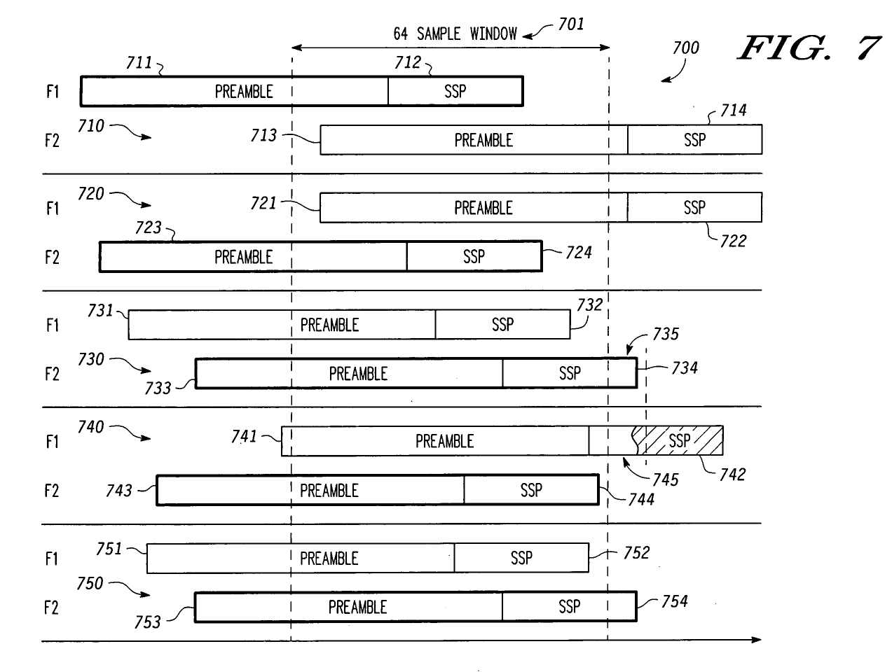

The exemplary procedure, as described above, can be implemented as noted using a processor or the like and an operating system and suitable software. It will be appreciated that an exemplary apparatus capable of selecting the strongest signal in accordance with various exemplary embodiments of the present invention is shown in FIG. 6. A receiver 601, or a corresponding receiver module in an exemplary receiver or transceiver can be equipped with a Media Access Control (MAC) controller 602 located in a MAC portion of the receiver 601 and can be used for controlling access to and retrieval of information from the lower layers of the device such as the Physical (PHY) layer in accordance with MAC oriented protocol parameters. The PHY layer can contain components configured to perform activities associated with transferring information across a physical medium such as an air interface, an optical interface, a wired interface or the like in accordance with PHY protocol parameters. The PHY layer contains a baseband controller 610 having a processor such as a digital signal processor (DSP) 611. The MAC layer and PHY layer components can be coupled using a bus 603 and the components in the exemplary receiver 600 can be operated from a system clock 601 or derivative thereof. In order to process incoming received signals such as a RF SIGNAL 1 IN 606 and a RF SIGNAL 2 IN 609, the exemplary receiver 600 is equipped with a finger 1 605 and a finger 2 608 containing for example an RF block and Analog to Digital Converter block and the like as will be appreciated. The finger 1 605 and the finger 2 608 are coupled to the DSP 611 by links 604 and 607 respectively which can be a special high speed data connection for the sampled signal data or the like provided the speed is high enough to support UWB signal rates.

To better appreciate the scenarios capable of being addressed using the inventive concepts discussed and described herein, a diagram of exemplary signal reception cases on finger F1 and finger F2 is shown in FIG. 7. Exemplary scenarios 710, 720, 730, 740, and 750 show different situations for reception, acquisition, lock and unlock of signals on fingers F1 and F2 and which signal is chosen as the strongest signal. It should be noted that the signal chosen as the strongest signal will be shown using a bold lineweight, and further, the signal with a larger signal metric will be shown as relatively thicker. It will be appreciated that while shown as relatively thicker, the magnitude is not necessarily shown to scale and is for illustrative purposes. It is also important to note that a 64 sampling cycle window is shown as two vertical dotted lines and represents the processing window for the exemplary receiver, baseband controller or the like with the time axis extending leftward. Thus, the left hand side of the figure outside the window represents signal elements which have been processed, the signal elements inside the window are presently being processed, and the signal elements on the right hand side of the figure outside the window are signal elements which have yet to be processed.

In the first exemplary scenario 710, a signal received on finger F1, has a preamble 711 the end of which is being processed and an SSP 712 which marks the beginning of, for example, a signal lock condition. The signal received on finger F2 has a preamble 713 which is being processed and an SSP 714 which has yet to be processed. In accordance with exemplary scenario 710, the signal on finger F 1 will be chosen as the strongest signal since the SSP 712 was received before reception of the SSP 714 on finger F2. In exemplary scenario 720, a situation is shown where the signal on finger F1 includes a preamble 721 which is being processed and an SSP 722 which has yet to be processed. However, the signal on finger F2 includes a preamble 723 which is being processed and an SSP 724 which is also being processed. Since the SSP 724 has been received prior to the reception of SSP 722, the signal on finger F2 is chosen as the strongest signal.

In exemplary scenario 730, the signal on finger F1 includes a preamble 731 and an SSP 732 which are already being processed. It can be seen that the signal on finger F2 has a relatively larger signal metric, such as signal level, and includes a preamble 733. It can be seen that an SSP 734 for the signal on finger F2 has begun to be processed and, since the signal metric for the signal on finger F2 is larger than that of FI, the signal on F2 is a desirable candidate for the strongest signal. Accordingly, a smaller validation window 735 having a smaller number of sample cycles, such as four sample cycles, can be established to validate the reception of the SSP 734 on finger F2. After a successful validation of the SSP 734, the signal on finger F2 will be chosen as the strongest signal. In a similar exemplary scenario 740, a signal on finger F1 includes a preamble 741 and an SSP 742 which is shown partially corrupted. The signal on finger F1 has a higher magnitude signal metric than the signal on finger FI. The signal on finger F2 includes a preamble 743 and an SSP 744 and has a lower magnitude signal metric than the signal on finger F1. Because of the signal corruption shown, the SSP 742 will fail to be validated within the validation window 745, and the signal on finger F2 will be chosen as the strongest signal even though the signal metric is of a lesser magnitude.

In a further exemplary scenario 750, a signal on finger F1 includes a preamble 751 and an SSP 752. A signal on finger F2 includes a preamble 753 and an SSP 754. With all else being equal, a general rule is that the first finger to experience a lock will be chosen as the strongest signal. However, in the event of a successful validation of the SSP 754, the signal on finger F2 will be chosen as the strongest signal.

Conclusion

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

What is claimed is:

1. A method for determining a strongest of a radio signal received on at least two signal paths in an Ultra Wideband (UWB) receiver, the method comprising:
determining, during a programmable interval, a signal metric associated with the radio signal in a first of the at least two signal paths and a signal metric associated with the radio signal in a second of the at least two signal paths; and
establishing a candidate for the strongest of the radio signal based on the signal metric in the first signal path, the signal metric in the second signal path, and a rule set

2. A method in accordance with claim 1, wherein:
the first signal path is associated with a first clock domain and the second signal path is associated with a second clock domain, the first clock domain and the second clock domain being independent clock domains,
the signal metric in the first of the at least two signal paths is available to the second of the at least two signal paths and the signal metric in the second of the at least two signal paths is available to the first of the at least two signal paths during the establishing, and
wherein the first clock domain and the second clock domain are synchronized.

3. A method in accordance with claim 1, further comprising:
establishing, as the candidate for the strongest of the radio signal, the radio signal received on one of the first signal path and the second signal path based on which one of the signal metric in the first signal path and the signal metric in the second signal path crosses a threshold to form an established candidate,
wherein:
the determining on an other of the first signal path and the second signal path continues when the established candidate is formed, and
the threshold is updated with a value associated with the one of the signal metric in the first signal path and the signal metric in the second signal path to form an updated threshold.

4. A method in accordance with claim 3, further comprising:
establishing, as a new candidate for the strongest of the radio signal, the radio signal received on the other of the first signal path and the second signal path if the signal metric associated with the other of the first signal path and the second signal path crosses the updated threshold.

5. A method in accordance with claim 3, wherein the establishing as the candidate for the strongest of the radio signal further includes establishing as the candidate for the strongest of the radio signal the radio signal received on the one of the first signal path and the second signal path based on which one of the signal metric in the first signal path and the signal metric in the second signal path crosses the threshold to form an established candidate,
wherein:
the determining on an other of the first signal path and the second signal path is resumed after the establishing the candidate, and
the threshold is updated with a value associated with the with the one of the signal metric in the first signal path and the signal metric in the second signal path.

6. A method in accordance with claim 3, wherein the threshold includes a peak signal to noise ratio (SNR) corresponding to a local maxima for the signal metric.

7. A method in accordance with claim 5, wherein the rule set includes:
if an event is detected on the one of the first signal path and the second signal path; and
if the signal metric associated with the radio signal received on the other of the first signal path and the second signal path does not cross the updated threshold,
then the radio signal received on the one of the first signal path and the second signal path is established as the strongest of the radio signal.

8. A method in accordance with claim 5, wherein the rule set includes:
if an event is detected on the one of the first signal path and the second signal path; and
if the signal metric associated with the radio signal received on the other of the first signal path and the second signal path crosses the updated threshold,
then the radio signal received on the one of the first signal path and the second signal path is established as the strongest of the radio signal.

9. A circuit for determining a strongest signal received in an Ultra Wideband (UWB) receiver, the circuit comprising:
a first signal path and a second signal path associated with a first received signal and a second received signal respectively, the first signal path and the second signal path associated with a first clock domain and a second clock domain;
a processor coupled to the first signal path and the second signal path, the processor configured to:
synchronize the first clock domain and the second clock domain
calculate a signal metric associated with the first received signal and the second received signal; and
establish one of the first received signal and the second received signal as the strongest signal based on the signal metric and a rule set.

10. A circuit in accordance with claim 9, wherein the processor is further configured to:
calculate, during a programmable time interval, the signal metric associated with the first received signal and the second received signal; and
establish a candidate for the one of the first received signal and the second received signal as the strongest signal based on the signal metric in the first signal path, the signal metric in the second signal path, and the rule set,
wherein:
the first clock domain and the second clock domain include independent clock domains, and
the signal metric in the first signal path is available to the second signal path and the signal metric in the second signal path is available to the first signal path when the processor establishes the candidate for the one.

11. A circuit in accordance with claim 10, wherein the processor, in establishing the candidate for the one of the first received signal and the second received signal as the strongest signal, is further configured to:
establish, as the candidate for the one of the first received signal and the second received signal as strongest signal, the signal received on one of the first signal path and the second signal path based on which one of the signal metric in the first signal path and the signal metric in the second signal path crosses a threshold to form an established candidate,
wherein:
the processor is configured to continue calculating on an other of the first signal path and the second signal path when the established candidate is formed, and
the processor is configured to update the threshold with a value associated with the one of the signal metric in the first signal path and the signal metric in the second signal path to form an updated threshold.

12. A circuit in accordance with claim 11, wherein the processor in establishing the candidate for the one of the first received signal and the second received signal as the strongest signal, is further configured to:
establish, as a new candidate for the one of the first received signal and the second received signal as the strongest signal, the signal received on the other of the first signal path and the second signal path if the signal metric associated with the other of the first signal path and the second signal path crosses the updated threshold.

13. A circuit in accordance with claim 11, wherein the processor, in establishing the candidate for the one of the first received signal and the second received signal as the strongest signal, is further configured to:
establish as the candidate for the one of the first received signal and the second received signal as the strongest signal, the signal received on the one of the first signal path and the second signal path based on which one of the signal metric in the first signal path and the signal metric in the second signal path crosses the threshold to form an established candidate,
wherein:
the processor is configured to continue calculating on an other of the first signal path and the second signal path after the establishing the candidate, and
the processor is configured to update the threshold with a value associated with the with the one of the signal metric in the first signal path and the signal metric in the second signal path.

14. A circuit in accordance with claim 11, wherein the threshold includes a peak signal to noise ratio (SNR) corresponding to a local maxima for the signal metric.

15. A circuit in accordance with claim 9, wherein the processor is further configured to:
compare the signal metric in the first signal path and the signal metric in the second signal path with a threshold associated with the signal metric;
establish, as the candidate for the one of the first received signal and the second received signal as the strongest signal, the signal received on one of the first signal path and the second signal path based on which one of the signal metric in the first signal path and the signal metric in the second signal path crosses the threshold to form the established candidate,
wherein:
the processor is configured to continue processing on an other of the first signal path and the second signal path after the establishing the candidate, and
the processor is configured to updated the threshold with a value associated with the with the one of the signal metric in the first signal path and the signal metric in the second signal path.

16. A circuit in accordance with claim 11, wherein the rule set includes:
if an event is detected on the one of the first signal path and the second signal path; and
if the signal metric associated with the signal received on the other of the first signal path and the second signal path does not cross the updated threshold,
then the signal received on the one of the first signal path and the second signal path is established as the strongest signal.

17. A circuit in accordance with claim 11, wherein the rule set includes:
if an event is detected on the one of the first signal path and the second signal path; and
if the signal metric associated with the signal received on the other of the first signal path and the second signal path crosses the updated threshold,
then the signal received on the one of the first signal path and the second signal path is established as the strongest signal.

18. A system for determining a strongest radio signal received in an Ultra Wideband (UWB) device, the system comprising:
a Media Access Control (MAC) portion; and
a Physical Layer (PHY) portion coupled to the MAC portion, the PHY portion including:
a first signal path and a second signal path; and
a baseband controller coupled to the first signal path and the second signal path, the baseband controller configured to
measure a signal metric associated with a first radio signal on the first signal path, and a signal metric associated with a second radio signal on the second signal path to form a measured signal metric; and
establish one of the first radio signal and the second radio signal as the strongest radio signal based on the measured signal metric and a rule set.

19. A system as recited in claim 18, wherein the system is implemented as an integrated circuit device.

20. A system as recited in claim 18, wherein the signal metric includes a peak signal to noise ratio (SNR).
